(19) United States
(12) Patent Application Publication
(10) Pub. No.: US 2003/0126720 A1
(43) Pub. Date: Jul. 10, 2003

(54) Hinge device

(76) Inventor: Hsin-Chiang Huang, Taipei Hsien (TW)

Correspondence Address: CHRISTIE, PARKER & HALE, LLP, 350 WEST COLORADO BOULEVARD, SUITE 500, PASADENA, CA, 91105, US

(21) Appl. No.: 10/044,416

(22) Filed: Jan. 10, 2002

(51) Int. Cl. E05D 11/08

(52) U.S. Cl. 16/342

(57) ABSTRACT

A hinge device includes female and male connecting members with two mounting sections fastened to two components of an electronic device for relative rotational movement. A tubular sleeve section of the female connecting member is formed integrally with the mounting section and confines an accommodation space therein. A cylindrical section of the male connecting member is formed integrally with the mounting section and is insertable into and is frictionally rotatable in the accommodation space. A grease receiving channel portion is formed in an outer surrounding surface of the cylindrical section, and includes two opposing channels and an interconnecting groove communicating with the channels such that grease is distributed evenly therein for obtaining a good lubricating effect.

### BACKGROUND OF THE INVENTION

1. Field of the Invention

This invention relates to a hinge device, more particularly to a hinge device adapted to be connected between two components of an electronic device, such as a portable computer, PDA, or the like, for relative rotational movement.

2. Description of the Related Art

Referring to FIG. 1, a conventional hinge device is shown to include female and male connecting members 10,20 which respectively include flat first and second mounting sections 102,112 with fastening holes 103,114 to be fastened to two components (not shown). The female connecting member 10 further includes a tubular sleeve section 101 extending from the first mounting section 102. The male connecting member 11 further includes a cylindrical section 111 which extends from the second mounting section 112 and which is insertable into and which is frictionally rotatable relative to the sleeve section 101. An abutting wall 113 is disposed between the second mounting section 112 and the cylindrical section 111 and abuts against the sleeve section 101 so as to permit frictionally rotatable movement between the male and female connecting members 11,10. A plurality of annular grease receiving grooves 115 are formed in the outer surface of the cylindrical section 111.

Since it is required to fill grease in the grease receiving grooves 115 before insertion of the cylindrical section 111 into the sleeve section 101, and since grease cannot be refilled after assembly of this hinge device, a reduction in the lubricating effect and interrupted rotational movement are encountered after a period of use. Further, no retaining means is provided for preventing axial movement of the cylindrical section 111 away from the sleeve section 101, thereby resulting in undesired removal of the cylindrical section 111 from the sleeve section 101.

### SUMMARY OF THE INVENTION

The object of the present invention is to provide a hinge device which can provide a good lubricating effect between two connecting members even after a long period of use.

Another object of the present invention is to provide a hinge device which can ensure rotational connection between the two connecting members.

According to this invention, the hinge device includes female and male connecting members which include respectively first and second mounting sections extending in a longitudinal direction and adapted to be fastened to two components for relative rotational movement. The female connecting member further includes a tubular sleeve section which has a proximate peripheral edge portion formed integrally with the first mounting section, and a surrounding wall extending from the proximate peripheral edge portion in the longitudinal direction to terminate at a distal peripheral edge portion and confining an accommodation space therein. The male connecting member further includes a cylindrical section formed integrally with and extending from the second mounting section in the longitudinal direction. The cylindrical section terminates at an insert end portion, and is insertable into the accommodation space via the insert end portion. The cylindrical section has an outer surrounding surface disposed to face and to be frictionally rotatable relative to the surrounding wall about an axis in the longitudinal direction. A grease receiving channel portion is formed in the outer surrounding surface. The grease receiving channel portion includes proximate and distal channels which are disposed respectively proximate and distal to the second mounting section and which are spaced apart from each other in the longitudinal direction, and an interconnecting groove which extends to communicate with the proximate and distal channels.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is an exploded perspective view of a conventional hinge device;

FIG. 2 is a side view of a preferred embodiment of a hinge device according to this invention, showing a state before a tubular sleeve section is bent;

FIG. 3 is an exploded perspective view of the preferred embodiment; and

FIG. 4 is a perspective view of the preferred embodiment when assembled onto a portable computer.

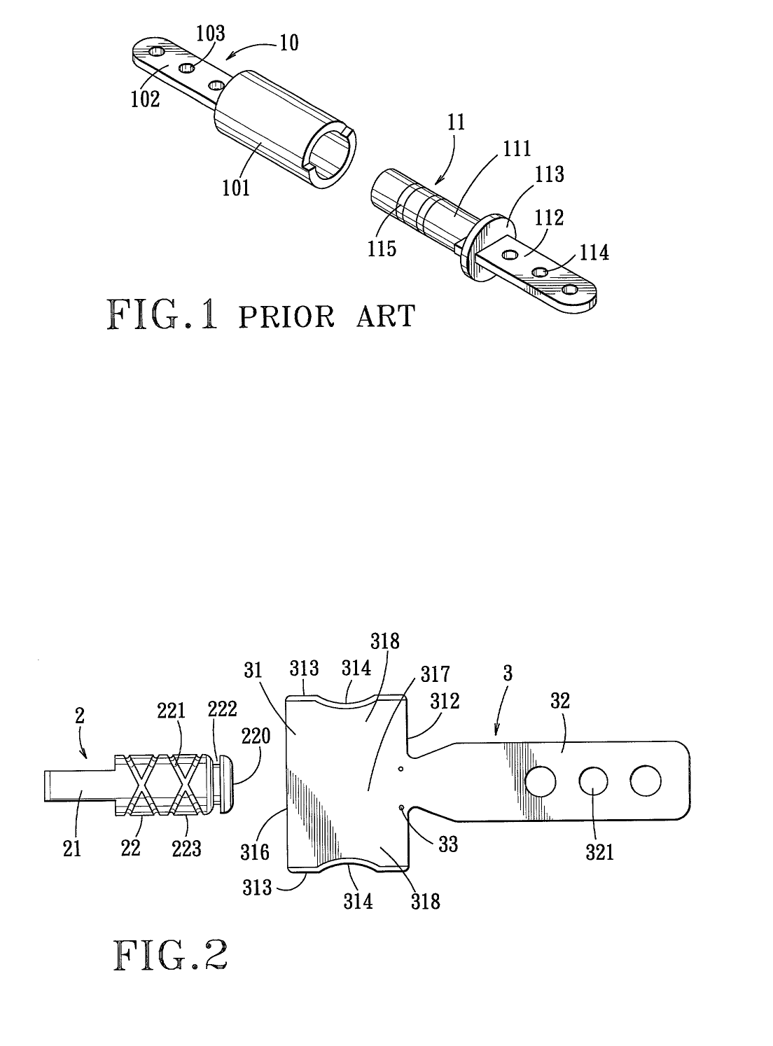

### DETAILED DESCRIPTION OF THE PREFERRED EMBODIMENT

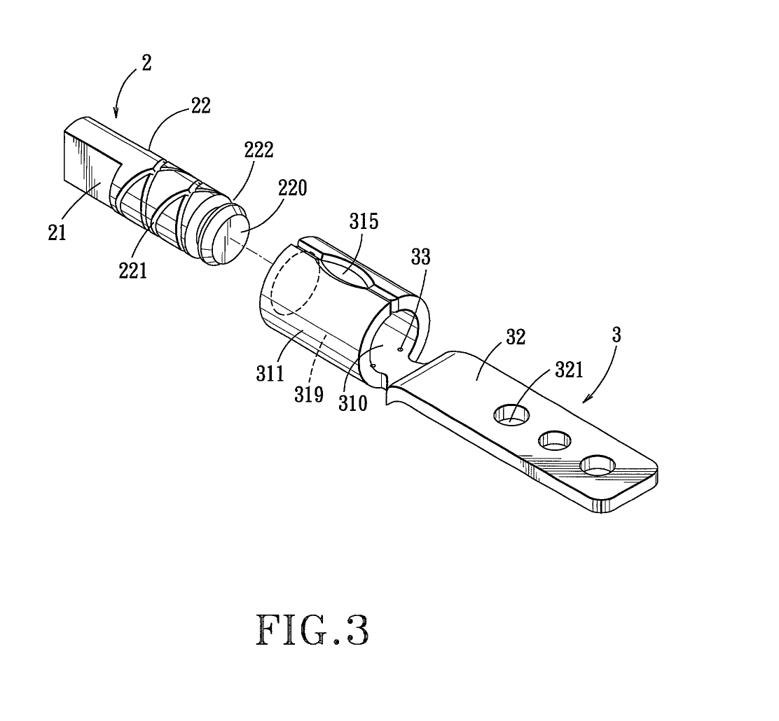

Referring to FIGS. 2 and 3, the preferred embodiment of the hinge device according to the present invention is shown to comprise female and male connecting members 3,2.

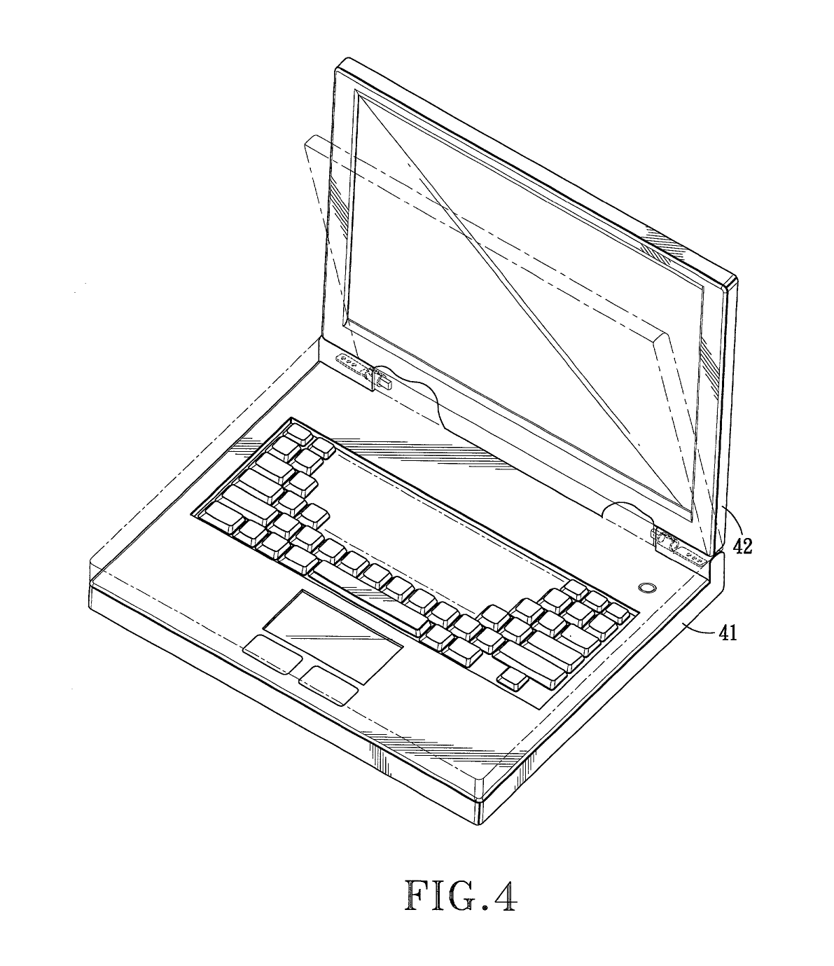

The female connecting member 3 includes a first mounting section 32 which extends in a longitudinal direction, and which is formed with a plurality of fastening holes 321 so as to be adapted to engage fasteners (not shown) to be fastened to one component 41 of an electronic device, such as a main body of a portable computer, as shown in FIG. 4. A tubular sleeve section 311 is made from a rectangular metal plate 31 which is formed integrally with the first mounting section 32. The plate 31 has a proximate peripheral edge portion 312 which is connected to the first mounting section 32, and a surrounding wall which extends from the proximate peripheral edge portion 312 in the longitudinal direction to terminate at a distal peripheral edge portion 316. The surrounding wall includes a base portion 317 which extends from the first mounting section 32 in the longitudinal direction, and two jaw portions 318 which extend respectively from lateral sides of the base portion 317 in a first transverse direction relative to the longitudinal direction, and which are bent towards each other in a second transverse direction transverse to the first transverse and longitudinal directions so as to form an inner holding wall surface 310 that confines an accommodation space 319. The jaw portions 318 terminate at two opposing edge surfaces 313 which define a clearance 315 therebetween that communicates with the accommodation space 319. Each of the opposing edge surfaces 313 has a recess 314 which extends inwardly and away from the clearance 315 to form an enlarged space in the clearance 315. Two protrusions 33 are disposed on the inner holding wall surface 310 adjacent to the first mounting section 32.

The male connecting member 2 includes a second mounting section 21 which extends in the longitudinal direction and which is adapted to be fastened to the other component 42 of the electronic device, such as a covering panel display of the portable computer, as shown in FIG. 4. A cylindrical section 22 is formed integrally with and extends from the second mounting section 21 in the longitudinal direction to terminate at an insert end portion 220. The cylindrical section 22 is insertable into the accommodation space 319 via the insert end portion 220, and has an outer surrounding surface 223 disposed to face and to be frictionally rotatable relative to the inner holding wall surface 310 about an axis in the longitudinal direction so as to permit rotational movement of the covering panel display 42 relative to the main body 41. As mentioned above, when the cylindrical section 22 is inserted into the accommodation space 319, the jaw portions 318 can be squeezed to bring the opposing edge surfaces 313 to move closer to each other, thereby increasing friction force between the outer surrounding surface 223 and the inner holding wall surface 310 so as to hold the covering panel display 42 at a desired opened angle relative to the main body 41.

Further, the outer surrounding surface 223 has a grease receiving channel portion 221 formed therein. The grease receiving channel portion 221 includes proximate and distal channels which are disposed respectively proximate and distal to the second mounting section 21 and which are spaced apart from each other in the longitudinal direction, and interconnecting grooves which extend to communicate with the proximate and distal channels. That is, the interconnecting grooves extend to crisscross the proximate and distal channels so as to form the grease receiving channel portion 221 as a communicating crisscross structure. As such, the grease receiving channel portion 221 is exposed to the clearance 315 when the cylindrical section 22 is disposed in the accommodation space 319. In this state, grease can fill into the grease receiving channel portion 221 from the enlarged space of the clearance 315, and the grease can be distributed evenly in the outer surrounding surface 223, thereby resulting in a good lubricating effect. In addition, some grease can be received in the recesses 314 so as to ensure that the lubricating effect lasts even after a long period of use.

Moreover, an annular retaining groove 222 is formed in the outer surrounding surface 223 to guide the protrusions 33 to frictionally slide therein to form a retaining member that hinders movement of the cylindrical section 22 out of the accommodation space 319 in the longitudinal direction.

In assembly, the cylindrical section 22 is easily inserted into the accommodation space 319 of the sleeve section 311. Then, the sleeve section 311 is squeezed to increase the friction force therebetween. Thus, grease is filled easily in the grease receiving channel portion 221 from the clearance 315 to provide a lubricating effect for the rotational movement of the cylindrical section 22 relative to the sleeve section 311. Furthermore, by means of the retaining member, the cylindrical section 22 is hindered from moving out of the accommodation space 319.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

I claim:

1. A hinge device adapted to be connected between two components for relative rotational movement, said hinge device comprising:
a female connecting member including
a first mounting section extending in a longitudinal direction, and adapted to be fastened to one of the components, and
a tubular sleeve section having a proximate peripheral edge portion formed integrally with said first mounting section, and a surrounding wall which extends from said proximate peripheral edge portion in the longitudinal direction to terminate at a distal peripheral edge portion and which confines an accommodation space therein; and
a male connecting member including
a second mounting section extending in the longitudinal direction, and adapted to be fastened to the other one of the components, and
a cylindrical section formed integrally with and extending from said second mounting section in the longitudinal direction, terminating at an insert end portion, and insertable into said accommodation space via said insert end portion, said cylindrical section having an outer surrounding surface disposed to face and to be frictionally rotatable relative to said surrounding wall about an axis in the longitudinal direction, said outer surrounding surface having a grease receiving channel portion formed therein, said grease receiving channel portion including proximate and distal channels which are disposed respectively proximate and distal to said second mounting section and which are spaced apart from each other in the longitudinal direction, and an interconnecting groove which extends to communicate with said proximate and distal channels.

2. The hinge device of claim 1, wherein said interconnecting groove extends to crisscross at least one of said proximate and distal channels.

3. A hinge device adapted to be connected between two components for relative rotational movement, said hinge device comprising:
a female connecting member including
a first mounting section extending in a longitudinal direction, and adapted to be fastened to one of the components, and
a sleeve section having a base portion which is formed integrally with said first mounting section, which extends in the longitudinal direction, and which has two lateral sides disposed opposite to each other in a first transverse direction relative to the longitudinal direction, and two jaw portions which extend respectively from said lateral sides in a second transverse direction transverse to the longitudinal and first transverse directions, and which are bent towards each other, such that said jaw portions cooperate with said base portion to form an inner holding wall surface which confines an accommodation space, and such that said jaw portions terminate at two opposing edge surfaces that define a clearance therebetween which communicates with said accommodation space; and
a male connecting member including
a second mounting section extending in the longitudinal direction, and adapted to be fastened to the other one of the components, and
a cylindrical section formed integrally with and extending from said second mounting section in the longitudinal direction, terminating at an insert end portion, and insertable into said accommodation space via said insert end portion, said cylindrical section having an outer surrounding surface rotatable relative to said inner holding wall surface about an axis in the longitudinal direction, said outer surrounding surface having a grease receiving channel portion formed therein and exposed to said clearance.

4. The hinge device of claim 3, wherein said jaw portions are configured such that once said cylindrical section is inserted into said accommodation space, said jaw portions are squeezed to bring said opposing edge surfaces to move closer to each other, thereby increasing friction force between said outer surrounding surface and said inner holding wall surface.

5. The hinge device of claim 3, wherein said grease receiving channel portion includes proximate and distal channels which are disposed respectively proximate and distal to said second mounting section and which are spaced apart from each other in the longitudinal direction, and an interconnecting groove which extends to communicate with said proximate and distal channels.

6. The hinge device of claim 3, wherein each of said opposing edge surfaces has a recess extending inwardly and away from said clearance to form an enlarged space in said clearance to facilitate filling of grease in said grease receiving channel portion.

7. The hinge device of claim 3, further comprising a retaining member disposed between said inner holding wall surface and said outer surrounding surface adjacent to said first mounting section to hinder movement of said cylindrical section out of said accommodation space in the longitudinal direction.

8. The hinge device of claim 7, wherein said retaining member includes a plurality of protrusions disposed on said inner holding wall surface, and an annular retaining groove formed in said outer surrounding surface to guide said protrusions to frictionally slide therein.

9. The hinge device of claim 3, wherein said first mounting section is formed with at least one fastening hole adapted to engage a fastener to be fastened to the component.
